(19) United States
(12) Patent Application Publication
(10) Pub. No.: US 2017/0091717 A1
(43) Pub. Date: Mar. 30, 2017

(54) AUTO EXTRACTION OF TASKS FROM UNSTRUCTURED COMMUNICATIONS SUCH AS EMAILS AND MESSAGES

(71) Applicant: Yahoo! Inc., Sunnyvale, CA (US)

(72) Inventors: Prateeksha Uday Chandraghatgi, San Jose, CA (US); Abhay Gupta, Los Altos, CA (US); Ralph Rabbat, San Carlos, CA (US)

(21) Appl. No.: 14/866,508

(22) Filed: Sep. 25, 2015

(51) Int. Cl. G06Q 10/10; H04L 29/06; H04L 12/58

(52) U.S. Cl. CPC G06Q 10/1097; H04L 51/04; H04L 67/42

(57) ABSTRACT

In one embodiment, a task to be performed by an individual may be identified based, at least in part, on content of one or more electronic communications transmitted between the individual and at least one other individual. Information pertaining to the task may be stored such that the task is added to a list or calendar. At least a portion of the information pertaining to the task may be provided for presentation via a client device.

### BACKGROUND OF THE INVENTION

The present disclosure relates generally to computer implemented methods and apparatus for extraction of tasks from unstructured communications.

Task management software typically enables users to enter tasks that they wish to organize Often, the task management software enables users to create task lists, as well as change the layout in which the tasks are presented. Users can then view and track their progress with respect to completion of their tasks.

Task management software also typically enables users to create reminders for key dates and times. The task management software will then generate the reminders that have been created by the users.

### SUMMARY OF THE INVENTION

In one embodiment, a task to be performed by an individual may be identified based, at least in part, on content of one or more electronic communications transmitted between the individual and at least one other individual. Information pertaining to the task may be stored such that the task is added to a list or calendar. At least a portion of the information pertaining to the task may be provided for presentation via a client device.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a process flow diagram illustrating an example method of automatically extracting tasks from unstructured communications in accordance with various embodiments.

FIG. 3 is a diagram illustrating an example client device in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Current task management systems require a user to explicitly add a task to their task management list or calendar by interacting with a graphical user interface. This is typically performed by entering text that identifies the task or accepting a task that has been sent by another individual. Therefore, capturing and management of tasks has so far been solely the user's prerogative.

Today, many individuals communicate via unstructured communications such as short message service (SMS) messages and electronic mail messages. Through these communications, there are many opportunities for individuals to become aware of a task that they are expected to complete. Unfortunately, individuals may easily overlook a task or forget to complete a task that is discussed within electronic communications. Therefore, tasks communicated via unstructured communications represent potentials for missed opportunities.

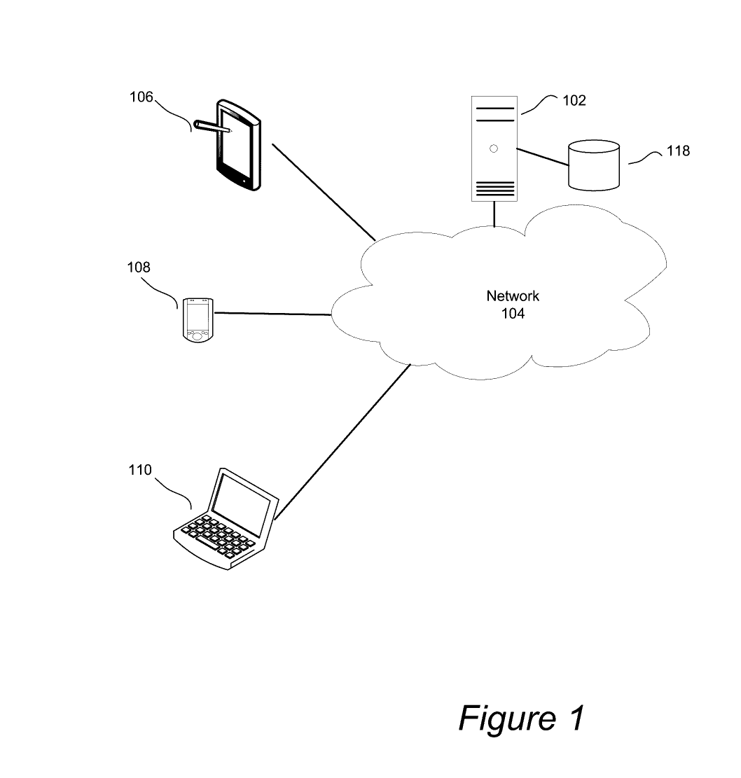

The disclosed embodiments enable a task management system to automatically identify tasks (e.g., action items) from unstructured communications. An example system via which the disclosed embodiments may be implemented will be described in further detail below with reference to FIG. 1.

FIG. 1 is a diagram illustrating an example system in which various embodiments may be implemented. The disclosed embodiments may be implemented in some centralized manner. This is represented in FIG. 1 by server(s) 102, which may correspond to multiple distributed devices and data store(s). The server(s) 102 and/or corresponding data store(s) may store user account data, user information such as user profiles, query logs, search logs, and/or content.

The server(s) 102 may be associated with a web site that provides a variety of services to its users. For example, the server(s) 102 may include a web server, electronic mail server, search server, and/or content server. Embodiments disclosed herein may be implemented via the server(s) 102 and/or the clients 106, 108, 110. More particularly, various features may be implemented via a task management application installed on the clients 106, 108, 110 and/or the server(s) 102. More particularly, tasks may be automatically identified by the server(s) 102 and/or the clients 106, 108, 110. In some embodiments, the task management application may be integrated with a homescreen application that automatically updates a homescreen of a client device. The disclosed embodiments may be implemented via software and/or hardware.

A task management application may be implemented on any number of servers although only a single server 102 is illustrated for clarity. The client devices 106, 108, 110 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The disclosed embodiments may be practiced in a wide variety of network environments (represented by network 104) including, for example, TCP/IP-based networks, telecommunications networks, wireless networks, etc. In addition, computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A task management application may extract tasks for a particular user. Generally, a user may be identified by one or more identifiers. Example identifiers include, but are not limited to a user account identifier, browser identifier, and/or client device identifier. For example, a user account may be associated with a social network account or electronic mail account.

In some embodiments, the user may opt-in or opt-out of automated task extraction. This may be accomplished, for example, by logging in to a user account and opting in or out of automated task extraction via a graphical user interface. Alternatively, the user may opt-in or out of automated task extraction via a graphical user interface provided by a task management application on the client device.

The user may also establish preferences with respect to automated task extraction. The preferences may be submitted via the user account or locally via the client device. For example, the user may submit user preferences via a graphical user interface presented via the task management application. Preferences may include positive preferences and/or negative preferences (e.g., exclusions).

In accordance with various embodiments, the user may set up task extraction preferences with respect to the sources from which messages will be automatically monitored to identify tasks. More particularly, the user may identify or otherwise indicate one or more client devices from which messages will be monitored to identify tasks. For example, the user may submit a cell phone number for each mobile phone number for which SMS messages will be monitored. In addition, the preferences may identify or otherwise indicate specific applications, services, and/or user accounts (e.g., electronic mail accounts and/or social network accounts) from which the user would like tasks to be automatically extracted. For each user account from which the user would like tasks to be automatically extracted, the user may submit a user identifier (e.g., username or electronic mail address) and corresponding password.

In addition, the task extraction preferences established by the user may indicate whether he or she wishes monitoring of communications to be performed for messages transmitted by the user (e.g., outgoing messages) and/or messages received by the user (e.g., incoming messages). The task extraction preferences may further indicate whether the individual would like tasks extracted from messages that have been unopened or unread by the user, as well as messages that have not been opened or read by the user. Therefore, messages received and/or transmitted via the user account(s) may be parsed for extraction of tasks according to the user preferences.

In some embodiments, the user may further establish notification preferences that pertain to notifications of tasks that may be automatically extracted, stored and/or provided to the user. More particularly, the notification preferences may indicate a preferred timing as to when the user would like to receive notifications of tasks (e.g., task lists or newly/recently extracted tasks). For example, the preferences may indicate a specific time, a time of day (e.g., morning, afternoon, or evening), and/or frequency with which the user would like to receive notifications of tasks.

In addition, the notification preferences may indicate a preferred device, mode, and/or manner of communication via which task notifications (e.g., pertaining to newly/recently extracted tasks) are to be transmitted to the user. For example, the user may specify or otherwise indicate a cell phone number or electronic mail address via which tasks are to be transmitted. As another example, the user may indicate that they would like to like their auto-extracted tasks to be automatically added to a task list or calendar, which may be accessed by launching the task management application or logging in to a task management account via the server(s) 102. As another example, the user may specify or otherwise indicate location(s) within a screen of a client device in which tasks (e.g., newly/recently extracted tasks) are to be displayed and/or the amount of time tasks (e.g., newly/recently identified tasks) are to be displayed before being automatically removed from the screen.

As will be described in further detail below, the server(s) 102 and/or client devices 106, 108, 110 may identify tasks for which task information (may be presented via a client device of the user. Automated task extraction may include continuous monitoring of communications transmitted by and/or received by the user.

In accordance with various embodiments, the server(s) 102 may have access to one or more user logs 118 (e.g., user databases) into which user information is retained for each of a plurality of users. This user information or a portion thereof may include user preferences, one or more task lists, one or more user calendars, and/or contact list(s). In some instances, a task list may consist of only recently or newly generated tasks that have not yet been explicitly confirmed by the user. In other instances, a task list may include a “To-Do” list of the user, which may include extracted tasks that have been confirmed by the user. The user logs 118 may be retained in one or more memories that are coupled to the server 102.

A task list may be associated with a user. As described above, a user may be associated with one or more client devices and/or one or more user accounts. Therefore, automated task extraction may be facilitated across multiple client devices and/or accounts of the user.

Similarly, the client devices 106, 108, 110 may maintain a local copy of a task list or portion thereof. Moreover, a client device may have access to additional information that the server(s) 102 do not. Thus, a client device may generate and/or maintain a task list that is different from that maintained by the server(s) 102. In some embodiments, the client device and server(s) 102 may transmit task list updates between one another so that the task lists are consistent.

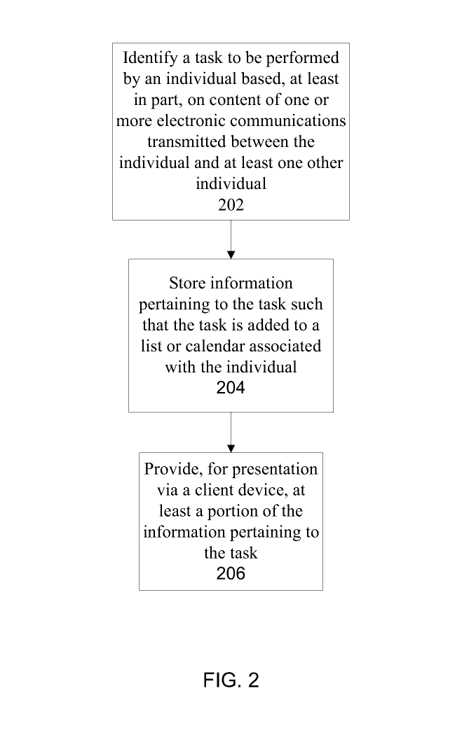

The disclosed embodiments may perform automated task extraction through one or more mechanisms. For example, tasks may be extracted through the use of natural language processing, pattern recognition, and/or entity detection. Patterns may be identified via application of various rules. In some embodiments, a prediction model may be trained to accurately identify tasks through the automated task extraction process. Example methods of performing automated task extraction will be described in further detail below with reference to FIG. 2.

FIG. 2 is a process flow diagram illustrating an example method of automatically extracting tasks from unstructured communications in accordance with various embodiments. A task to be performed by an individual may be identified at 202 based, at least in part, on content of one or more electronic communications transmitted between the individual and at least one other individual. More particularly, the electronic communications may include an electronic message transmitted by the individual and/or an electronic message received by the individual. Messages received by the user may include messages that have been opened or read by the user, as well as messages that have not been opened or read by the user. A task may be automatically extracted according to user preferences, as discussed above.

The electronic communications may include various types of messages. For example, messages may include, but are not limited to, electronic mail messages, SMS messages, messages sent during a chat session via an instant messaging application, and/or microblogging messages such as tweets or messages transmitted via a social network.

In addition, the electronic communications may be transmitted via various messaging applications, platforms, protocols, devices, or services. In some implementations, electronic communications may be transmitted via a component of a client device such as a mobile device.

In some instances, an electronic communication may include a digital voice message. To enable tasks to be extracted, the digital voice message may be converted from speech to text.

Task identification may include extracting (e.g., inferring) tasks from the content of the electronic communications. Task extraction may be performed via application of various mechanisms including, but not limited to, natural language processing, pattern recognition, or entity detection. Entities that may be detected include, but are not limited to, dates, times, names, addresses, venues, phone numbers, questions, and/or parts of speech (e.g., proper noun, verb, pronoun). In some embodiments, tasks may be extracted via application of a computer-generated model, which may be associated with the user. A computer-generated model may be trained using a training set of communications that are mapped to corresponding identified tasks.

Extraction of tasks may include parsing messages to identify language that is generally correlated with task planning. For example, messages may be parsed to identify language that indicates a request that the individual perform a task, an offer by the individual to perform the task, or a promise by the individual to perform the task. As another example, messages may be parsed to identify actions or events. For example, task planning or corresponding action items may be identified by language such as “I'll get back to you on that.” Therefore, language that implicitly and/or explicitly refers to a task or “action item” may be identified within various unstructured communications.

Identification of the task may include ascertaining a date and/or time associated with the task. More particularly, information may be extracted from the content of the communications that identifies a time by which the task is to be performed by the individual, a date by which the task is to be performed by the individual, a time at which the task is to be performed by the individual, and/or a date at which the task is to be performed.

In some instances, information that is extracted from the content of the communications may identify a venue or location at which the task is to be performed. For example, the information that is extracted may identify an address or a name of a venue.

In addition, a set of one or more individuals for whom or with whom the task is to be performed from may be identified from the electronic communications. More particularly, a set of individuals may be identified from the content of the electronic communications and/or metadata associated with the electronic communications. For example, an electronic communication may be sent to plan an event with at least one other individual. As another example, the electronic communication may have been transmitted to communicate a request that the individual perform the task, or may have been transmitted by the individual to offer or promise to perform the task.

Where the electronic communications include an electronic mail message, the metadata may include addressee(s) of the electronic mail message, as well as additional recipients such as those who are carbon copied on the electronic mail message. More particularly, where an electronic mail message is sent to or carbon copies a set of individuals, it may be inferred that the task is being performed for or with the set of individuals. For example, an electronic mail message may be sent to plan a group activity or meeting, where the message copies all individuals in the group. As another example, analysis of an electronic mail message that was received by the individual may indicate that the individual's friend Fred has asked him to make reservations for dinner on Saturday night.

To identify a set of individuals associated with the task, contact information associated with an addressee or recipient of a communication may be retrieved from a contact list (or address book) of the individual. More particularly, a name of a contact that corresponds to an addressee, recipient, and/or sender of an electronic communication may be retrieved. Where the task is one that has been promised by or offered by the individual, the name(s) of the addressee(s) and/or other recipient(s) may be retrieved. Similarly, where the task is one that the individual was asked to perform, the name of the sender of the communication requesting that the individual perform the task may be retrieved.

In some instances, a set of one or more individuals may be identified within the content of the communications. Where a match or approximate match between a name in a contact list can be identified for the set of individuals, the corresponding name may be retrieved. If two or more similar names are identified as a potential match, the name of the contact with whom the individual communicates most frequently (e.g., via a user account or client device) may be selected.

Information pertaining to the task may be stored at 204 such that the task is added to a list or calendar. In some instances, the task may be added to a list of newly or recently extracted tasks. For example, the list may identify tasks for which task information has not yet been transmitted to the user and/or tasks that have not yet been confirmed by the user. In other instances, the list may include a “To-Do list” that identifies tasks that the user should perform or complete. More particularly, the task may be added to a default list or calendar associated with the user. For example, the task may be added to a particular list or calendar identified in the user preferences.

The task information that is stored may identify a particular action that the individual is to perform or a particular event that the individual is to attend. In addition, the information that is stored may identify or otherwise indicate the corresponding set of individuals for whom the task or with whom the task is to be performed. In addition, the information that is stored may identify or otherwise indicate a time and/or date associated with the task. In some instances, the information may identify a venue or location associated with the task.

In addition, the information that is stored may identify a source from which the task was identified. For example, the information may indicate that the task was identified from a message sent by the individual to a particular user or a message received by the individual from a particular user. As another example, the information may indicate an account, application, device, and/or service via which the message was sent or received. Moreover, the information may include a date and time that the message was transmitted or received by the individual. The information may also include a link to the message from which the task was identified.

In accordance with various embodiments, the task may be added to a list or calendar in response to receiving a command from the individual. More particularly, at least a portion of the information pertaining to the task may be presented via a client device for presentation to the individual, as will be described in further detail below. For example, a task notification may be transmitted to the individual that asks the individual whether they would like to add a specific task (e.g., lunch at 12:00 Sep. 21, 2015 with Wendy) to their task list (or calendar). The individual may then decide whether they would like to add the task to their task list (e.g., To-Do list) or calendar. The individual may indicate whether they would like to add the task to their list or calendar by submitting a command. For example, the individual may confirm or deny whether they would like to add the task to their task list or calendar by interacting via a graphical user interface, clicking on a hypertext link within an electronic mail message or SMS message, or by submitting a voice command. The task list or calendar may be a default list calendar or may be identified by the individual, either in their user preferences or after confirming their intention to add the task to their task list or calendar.

User interaction with or response to the task information presented to the individual or lack thereof may be recorded in association with the user. A prediction model or task extraction rules may be updated based, at least in part, on the user interaction or lack thereof. For example, where a task is accepted or rejected by the user, the prediction model or task extraction rules may be updated accordingly. The prediction model or task extraction rules may be used to identify tasks, as described herein.

In other embodiments, the task may be identified and stored automatically without human intervention. For example, the task may be automatically stored in a list consisting of newly/recently extracted tasks or a To-Do list of the individual. As another example, the task may be automatically added to the appropriate date within a calendar of the individual. The individual may later view their task list or calendar to selectively delete tasks, as desired.

At least a portion of the information pertaining to the task may be provided at 206 for presentation via a client device. The information or portion thereof may be provided according to user preferences, as described herein. The information or portion thereof may be provided automatically or in response to a request from the individual.

Automated transmission of task information may be performed via various mechanisms. For example, task information may be transmitted automatically via an electronic communication such as an electronic mail message or SMS message. As another example, task information may be presented by displaying the task information within a homescreen of the client device or presenting audio information via a speaker of the client device.

Task information may also be provided in response to a request received from the individual. In some instances, an automated notification such as an SMS or electronic mail message may be transmitted to the individual to notify the individual of newly or recently extracted tasks for which task information may be retrieved. The individual may submit a request to view newly or recently identified tasks by logging in to his or her user account, via a task management application on the client device, or via interaction with a hypertext link within an electronic communication such as an electronic mail message or SMS message that has been automatically transmitted to the individual.

In some instances, the information or portion thereof may be presented via a display of the client device. For example, task information may be presented via a tile displayed within a homescreen of the client device or a stream of content presented via the client device. The individual may view a larger version of the tile by clicking on the tile.

In other instances, the information or portion thereof may be provided via audio data via a speaker of the client device. For example, task information may be converted from text to speech and transmitted via a speaker of the client device.

The information may be presented in the form of a task list, a calendar, or portion thereof. In some instances, the information that is provided may serve as a notification of a newly or recently extracted task. For example, the information may be provided in conjunction with a request to the individual asking whether the individual would like to add the task to their calendar or task list. In other instances, the information may serve as a reminder of a previously extracted task. In yet other instances, the information may be presented in response to a request submitted by the individual.

Information may be provided immediately upon identification of the task. Alternatively, the information may be provided at another time, which may be determined according to user preferences, the date associated with the task, and/or the time associated with the task. For example, the individual may be notified of the task the day prior to the task.

The task information that is presented may identify an action or event. In addition, the task information may indicate a date, a time, a location, and/or other individual(s) that are pertinent to the task.

In accordance with various embodiments, information pertaining to the source of the task (e.g., the message from which the task was identified) may be provided for presentation via the client device. In some instances, the information may identify the specific message from which the task was extracted. More particularly, the information may indicate the identity of the sender, addressee(s), and/or recipient(s) of the message, the date that the message was transmitted, the time that the message was transmitted, and/or an account/application via which the message was transmitted. For example, the information may indicate that the task was extracted from an electronic mail message received from Harry on Sep. 8, 2015. In other instances, a copy of the actual message that was transmitted or received by the individual may be presented via a graphical user interface.

In some embodiments, the information that is presented to the individual via the client device may enable the individual to complete the task. For example, the individual may have received a message from a friend that asked if they have made a reservation for dinner on Saturday night at the Cheesecake Factory. In some instances, the information may include a Uniform Resource Locator (URL) or a hypertext link that enables the user to complete the task. For example, the information presented via the client device may include a URL or hypertext link that enables the user to make a dinner reservation via OpenTable. In other instances, the individual may be prompted to respond to the friend by opening the message via the corresponding messaging application and displaying the message via a graphical user interface.

In some instances, the individual may initiate task reminders for tasks. As tasks are completed, the individual may remove the tasks from their To-Do list(s) or calendar(s).

Task management has become a complex matter that can consume a large amount of mental energy if not managed effectively. The disclosed embodiments enable tasks that are discussed during conversations to be captured in a timely manner. By extracting or inferring action items from free form conversations within electronic messages, these action items may be presented to the user in a form that enables the user to easily track them going forward.

Network Environment

Automated task extraction and management may be facilitated in any of a wide variety of computing contexts. For example, implementations are contemplated in which users interact with a diverse network environment via any type of computer (e.g., desktop, laptop, tablet, etc.), media computing platforms (e.g., cable and satellite set top boxes and digital video recorders), handheld computing devices (e.g., PDAs), cell phones, or any other type of computing or communication platform.

Implementations are contemplated in which users interact with a diverse network environment. For example, the network environment may include a variety of networks.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Tasks and any corresponding content may be identified or retrieved via a content distribution network. A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Tasks may also be extracted and presented in a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling devices via an ad hoc arrangement or configuration. A peer-to-peer network may employ some devices capable of operating as both a “client” and a “server.”

In some embodiments, the network environment may include a wireless network that couples client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Communications transmitted via a network typically include signal packets. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

Signal packets may be communicated between devices of a network, such as, for example, to one or more sites employing a local network address. A signal packet may, for example, be communicated over the Internet from a user site via an access device coupled to the Internet. Likewise, a signal packet may be forwarded via network devices to a target site coupled to the network via a network access device, for example. A signal packet communicated via the Internet may, for example, be routed via a path of gateways, servers, etc. that may route the signal packet in accordance with a target address and availability of a network path to the target address.

Various embodiments may be employed via one or more servers. A computing device that is capable of sending or receiving signals, such as via a wired or wireless network, or capable of processing or storing signals, such as in memory as physical memory states, may operate as a server. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Tasks s or associated content may be identified or provided via a content server. A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

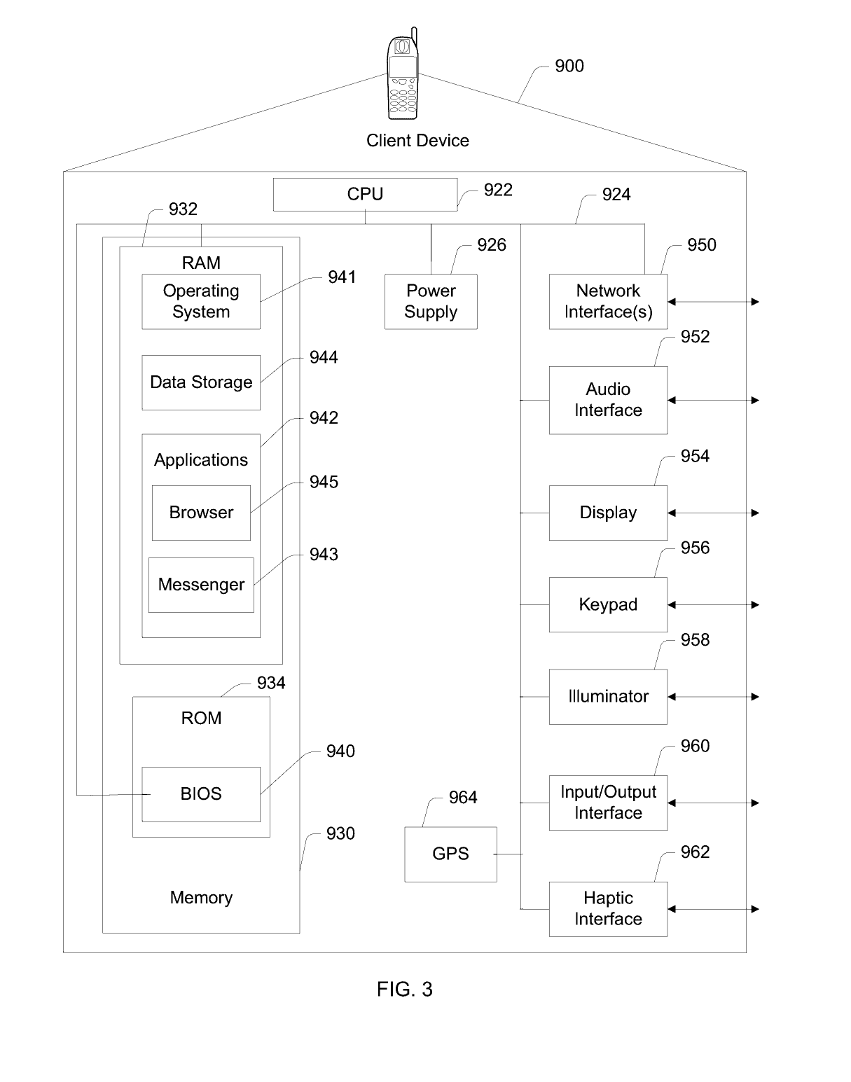

FIG. 3 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 900 may include one or more central processing units (CPUs) 922, which may be coupled via connection 924 to a power supply 926 and a memory 930. The memory 930 may include random access memory (RAM) 932 and read only memory (ROM) 934. The ROM 934 may include a basic input/output system (BIOS) 940.

The RAM 932 may include an operating system 941. More particularly, a client device may include or may execute a variety of operating systems, including a personal computer operating system, such as a Windows, iOS or Linux, or a mobile operating system, such as iOS, Android, or Windows Mobile, or the like. The client device 900 may also include or may execute a variety of possible applications 942 (shown in RAM 932), such as a client software application such as messenger 943, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 944. A client device may also include or execute an application such as a browser 945 to perform a variety of possible tasks, such as browsing, searching, playing various forms of content, including locally stored or streamed video, or games (such as fantasy sports leagues).

The client device 900 may send or receive signals via one or more interface(s). As shown in this example, the client device 900 may include one or more network interfaces 950. The client device 900 may include an audio interface 952. In addition, the client device 900 may include a display 954 and an illuminator 958. The client device 900 may further include an Input/Output interface 960, as well as a Haptic Interface 962 supporting tactile feedback technology.

The client device 900 may vary in terms of capabilities or features. Claimed subject matter is intended to cover a wide range of potential variations. For example, a cell phone may include a keypad such 956 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 964 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

In some embodiments, an identity of the user (e.g., owner) of the client device may be statically configured. Thus, the device may be keyed to an owner or multiple owners. In other embodiments, the device may automatically determine the identity of the user of the device. For instance, a user of the device may be identified by deoxyribonucleic acid (DNA), retina scan, and/or finger print. From the identity of the user, a user profile and/or client profile may be identified or obtained.

Regardless of the system's configuration, it may employ one or more memories or memory modules configured to store data, program instructions for the general-purpose processing operations and/or the inventive techniques described herein. For example, the program instructions may control the operation of one or more applications. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying a task to be performed by an individual based, at least in part, on content of one or more electronic communications transmitted between the individual and at least one other individual;
storing, by at least one processor, information pertaining to the task such that the task is added to a list or calendar associated with the individual; and
providing, for presentation via a client device, at least a portion of the information pertaining to the task.

2. The method as recited in claim 1, wherein the one or more electronic communications comprise an electronic message transmitted by the individual or an electronic message received by the individual.

3. The method as recited in claim 1, further comprising:
identifying, from at least one of the content of the electronic communications or metadata associated with the electronic communications, a set of one or more individuals for whom the task is to be performed or with whom the task is to be performed;
wherein the information pertaining to the task indicates the corresponding set of individuals.

4. The method as recited in claim 1, wherein identifying a task comprises:
ascertaining at least one of a date or time associated with the task;
wherein the information pertaining to the task indicates at least one of the time or date.

5. The method as recited in claim 1, wherein identifying a task to be performed comprises performing at least one of natural language processing, pattern recognition, or entity detection.

6. The method as recited in claim 1, wherein the at least a portion of the information pertaining to the task is provided prior to storing the information pertaining to the task such that the task is added to a list or calendar, the method further comprising:
receiving a command, via the client device;
wherein the information pertaining to the task is stored such that the task is added to the list or calendar in response to receiving the command.

7. The method as recited in claim 1, wherein at least one of identifying the task, storing the information pertaining to the task, or providing at least a portion of the information pertaining to the task are performed automatically without human intervention.

8. At least one non-transitory computer-readable storage medium storing thereon computer-readable instructions, comprising:
instructions for identifying a task to be performed by an individual based, at least in part, on content of one or more electronic communications transmitted between the individual and at least one other individual;
instructions for storing information pertaining to the task such that the task is added to a list or calendar associated with the individual; and
instructions for providing, for presentation via a client device, at least a portion of the information pertaining to the task.

9. The non-transitory computer-readable storage medium as recited in claim 8, wherein the one or more electronic communications comprise an electronic message transmitted by the individual or an electronic message received by the individual.

10. The non-transitory computer-readable storage medium as recited in claim 8, further comprising:
instructions for identifying, from at least one of the content of the electronic communications or metadata associated with the electronic communications, a set of one or more individuals for whom the task is to be performed or with whom the task is to be performed;
wherein the information pertaining to the task indicates the corresponding set of individuals

11. The non-transitory computer-readable storage medium as recited in claim 8, wherein identifying a task comprises:
ascertaining at least one of a date or time associated with the task;
wherein the information pertaining to the task indicates at least one of the time or date.

12. The non-transitory computer-readable storage medium as recited in claim 8, wherein identifying a task to be performed comprises performing at least one of natural language processing, pattern recognition, or entity detection.

13. The non-transitory computer-readable storage medium as recited in claim 8, wherein the at least a portion of the information pertaining to the task is provided prior to storing the information pertaining to the task such that the task is added to a list or calendar, further comprising:
instructions for obtaining a command, via the client device;
wherein the information pertaining to the task is stored such that the task is added to the list or calendar in response to the command.

14. The non-transitory computer-readable storage medium as recited in claim 8, wherein at least one of identifying the task, storing the information pertaining to the task, or providing at least a portion of the information pertaining to the task are performed automatically without human intervention.

15. An apparatus, comprising:
one or more processors; and
one or more memories storing thereon computer-readable instructions configured to:
identify a task to be performed by an individual based, at least in part, on content of one or more electronic communications transmitted between the individual and at least one other individual;
store information pertaining to the task such that the task is added to a list or calendar associated with the individual; and
provide, for presentation via a client device, at least a portion of the information pertaining to the task.

16. The apparatus as recited in claim 15, wherein the one or more electronic communications comprise an electronic message transmitted by the individual or an electronic message received by the individual.

17. The apparatus as recited in claim 15, wherein the computer-readable instructions are further configured to:
identify, from at least one of the content of the electronic communications or metadata associated with the electronic communications, a set of one or more individuals for whom the task is to be performed or with whom the task is to be performed;
wherein the information pertaining to the task indicates the corresponding set of individuals.

18. The apparatus as recited in claim 15, wherein identifying a task comprises:
ascertaining at least one of a date or time associated with the task;
wherein the information pertaining to the task indicates at least one of the time or date.

19. The apparatus as recited in claim 15, wherein the information pertaining to the task is stored in response to receiving a command via the client device.

20. The apparatus as recited in claim 15, wherein at least one of identifying the task, storing the information pertaining to the task, or providing at least a portion of the information pertaining to the task are performed automatically without human intervention.
